(19) United States
(12) Patent Application Publication
(10) Pub. No.: US 2009/0220912 A1
(43) Pub. Date: Sep. 3, 2009

(54) Dental Finishing, Sanding and/or Polishing Floss

(76) Inventor: Jeffrey T. Allen, Bloomington, IN (US)

Correspondence Address: Bruce J. Bowman;Bowman & Assoicates, Suite 106, 1016 3rd Ave. SW, Carmel, IN, 46032, US

(21) Appl. No.: 12/467,592

(22) Filed: May 18, 2009

Related U.S. Application Data
(63) Continuation-in-part of application No. 11/891,820, filed on Aug. 13, 2007.
(60) Provisional application No. 60/837,482, filed on Aug. 14, 2006.

(51) Int. Cl. A61C 3/00

(52) U.S. Cl. 433/142

(57) ABSTRACT

An abrading dental floss is characterized by dental floss formed of a fiber or fibrous material having a dental abrasive on at least a portion thereof suitable for polishing, sanding and/or finishing dental restorative material such as dental resin. The fiber is preferably a synthetic material. The dental abrading material is impregnated into or provided onto the dental floss. In one form, the dental abrading floss has an abrading section situated between lengths of the dental floss. The abrading polishing section may be formed of an alternating pattern of non-abrasive portions and abrasive portions along a length of the floss. The abrasive portions may be of a single grit or texture of the dental abrasive or may be of different grits of the dental abrasive. In another form, the dental abrading floss has a single grit of a dental abrasive along its entire length. In yet another form, the dental abrading floss comprises a plastic sheet of having a dental abrasive thereon or therein situated between lengths of the dental floss. The dental abrasive may be of a single grit or different grits of the dental abrasive. For different grits of the dental abrasive, it is preferred, but not necessary, that they gradually change in grit size.

### CROSS-REFERENCE TO RELATED APPLICATIONS

This patent application is a continuation-in-part of co-pending U.S. patent application Ser. No. 11/891,820 filed Aug. 13, 2007, entitled “Dental Finishing, Sanding and/or Polishing Floss” which claims the benefit of and/or priority to U.S. Provisional Patent Application Ser. No. 60/837,482 filed Aug. 14, 2006, entitled “Dental Finishing and Polishing Floss”, the entire contents of which are specifically incorporated herein by reference.

### BACKGROUND OF THE INVENTION

1. Field of the Invention

The present invention relates to dental floss/tape used for interproximal finishing, polishing and/or sanding of a dental restorative material.

2. Background Information

Resins rather than amalgams are now predominately used for filling cavities or other dental decay and/or as a general dental restorative material. These resins possess properties that closely match natural teeth with respect to structural properties such as cohesive strength, coefficient of thermal expansion and wearability. Also, aesthetic considerations such as color stability, refractive index, plaque repellency, polishability and opacity are important factors make resins a good choice as a dental restorative material.

These resins have good forming characteristics so that they can be shaped to fit a cavity area or molded into place in order to repair chipped or damaged teeth. However, it is necessary to shape the repaired area by polishing or sanding the resin once the resin is cured. For instance, when resin is placed in the interproximal surface of posterior teeth such as for fixing a cavity, a matrix band is used so that the resin does not bond to the adjacent tooth. As a result, resin can overflow past the margin of the floor of the cavity preparation causing an overhang that can create periodontal disease due to inflamed gingival or recurrent decay. It is optimal to create a tight, dense contact to prevent a food trap. One of the only ways to remove a resin overhang is to use a size 11 scalpel—which is not always effective and which traumatizes the gum tissue.

Another way to remove a resin overhang is to sand it with an abrasive. This may be accomplished by using a plastic strip that has a polishing material thereon. These plastic strips however, are not ideal. If one uses a plastic strip, the plastic strip will crumple and therefore be unable to allow the plastic strip to fit through the tight contact rendering the plastic strip useless. This may also be accomplished by using a metal strip that has a polishing material thereon. However, if one uses a metal strip, the metal does not contour to the curvature of the tooth and thus strips the contact thereby creating a food trap (e.g. food getting caught between the teeth). Moreover, with metal strips, the metal cuts the gum tissue to shreds.

It is therefore an object of the present invention to overcome the prior art deficiencies of dental restorative material polishing/sanding/finishing devices.

### SUMMARY OF THE INVENTION

The present invention is a dental abrading tool formed of dental floss for polishing, sanding and/or finishing (i.e. abrading) dental restorative material, the dental floss characterized by a fiber or fibrous material (collectively, fiber), the fiber having or incorporating a dental abrasive on at least a portion thereof that is suitable and/or appropriate for polishing, sanding, abrading and/or finishing dental restorative material such as dental resin. The fiber may be a man-made or synthetic fiber such as, but not limited to, nylon, rayon, Gore-tex® and/or the like.

In one form, the present dental floss has an abrading/polishing/finishing section (collectively, abrading section) situated between lengths or portions of the dental floss. The abrading section may be formed of a continuous portion of an abrasive or of an alternating pattern of non-abrasive portions and abrasive portions along a length of the dental floss. The abrasive/abrasive portions may be of a single grit of the dental abrasive or may be of different grits of the dental abrasive. For different grits of the dental abrasive, it is preferred, but not necessary, that they gradually change in grit size.

In one form, the dental floss has a single grit of a dental abrasive along its entire length.

In another form, the dental floss comprises a plastic sheet of having a dental abrasive thereon or therein situated between lengths of the dental floss, the dental floss again being formed of a fiber. The dental abrasive may be of a single grit of the dental abrasive or may be of different grits of the dental abrasive. For different grits of the dental abrasive, it is preferred, but not necessary, that they gradually change in grit size.

In one form, the dental abrasive may be provided on a strip of dental plastic situated between the dental floss.

The present invention will be more apparent upon reading the following detailed description in conjunction with the accompanying drawings.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 depicts an embodiment of a piece, strand or strip of dental finishing, polishing and/or sanding floss fashioned in accordance with the present principles;

FIG. 2 depicts another embodiment of a piece, strand or strip of dental finishing, polishing and/or sanding floss fashioned in accordance with the present principles; and

FIG. 3 depicts a further embodiment of a piece, strand or strip of dental finishing, polishing and/or sanding floss in fashioned accordance with the present principles.

Like reference numerals indicate the same or similar parts throughout the several figures.

A detailed description of the features, functions and/or configuration of the components depicted in the various figures will now be presented. It should be appreciated that not all of the features of the components of the figures are necessarily described. Some of these non discussed features as well as discussed features are inherent from the figures. Other non discussed features may be inherent in component geometry and/or configuration.

### DETAILED DESCRIPTION OF THE PREFERRED EMBODIMENTS

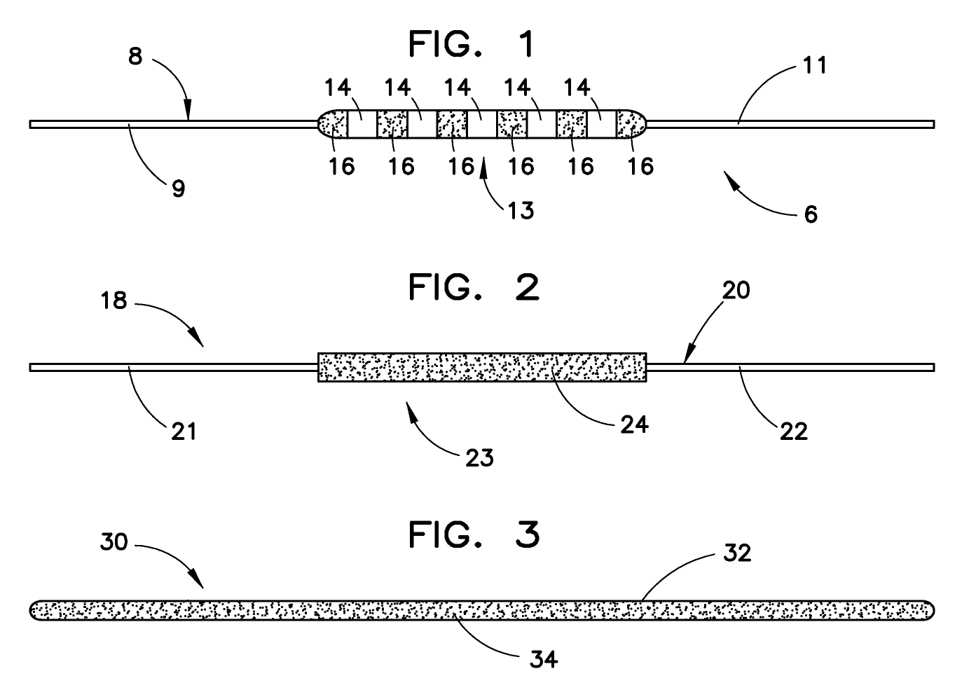

Referring to FIG. 1 there is depicted an exemplary embodiment of the present invention. Particularly, there is depicted a strip, piece or strand of dental finishing, polishing and/or sanding floss (collectively, dental abrasion or abrading floss), generally designated 6, fashioned in accordance with the present principles. The dental abrasion floss 6 is defined by a length of dental floss 8 that is made from a fiber or fibrous material (collectively, fiber) that is preferably, but not necessarily, man-made or synthetic such as, but not limited to, nylon, rayon, Gore-tex® or the like. As such, the length of dental floss 8 may be a continuous thread/strand/piece/strip and/or the like (collectively piece), or an individual piece of any length.

In accordance with the principles of the present invention, the length of dental floss 8 has a finishing/polishing/sanding (abrasion or abrading) section 13 situated between lengths 9 and 11 of the dental floss 8. It should be appreciated, that the abrasion section 13 is shown in FIG. 1 as an enlarged portion—this is for clarity to understand the nature of the abrading section 13 of the dental floss 8, but is not necessarily so. Particularly, the abrading/abrasion section 13 has been enlarged for detail in illustrating the alternating pattern of non-abrasive/abrading portions 14 and abrasive/abrading portions 16 along the length thereof. The abrading/abrasion section 13 is thus preferably the same size as the dental floss 8. Therefore, reference to FIG. 3 is made to show what the embodiment of FIG. 1 looks like without such enlargement of the abrading section 13.

In this embodiment, the abrasion or abrading section 13 is formed of an alternating pattern of non-abrasive/abrading portions 14 and abrasive/abrading portions 16 along the length of the abrasion or abrading section 13. The abrasion/abrading section 13 is impregnated into, coated onto or otherwise formed into/onto the dental floss 8. The abrasive/abrading portions 16 are formed of a gritty material such as is known in the art for finishing, polishing and/or sanding (abrading) a dental restorative material (e.g. a dental resin).

The abrasive/abrading portions 16, in one form, are each of the same grit or texture. Different dental abrasion/abrading flosses 6 (or abrasive/abrading sections 13 thereof) may have grit portions 16 of different grits or textures. For instance, one dental abrasion/abrading floss 6 may have “coarse” grit abrasive/abrading portions 16 for coarse finishing/polishing/sanding, one dental abrasion/abrading floss 6 may have “medium” grit abrasive/abrading portions 16 for medium finishing/polishing/sanding, and one dental abrasion/abrading floss 6 may have “fine” grit abrasive/abrading portions 16 for fine finishing/polishing/sanding.

Alternatively, in another form of the present invention, the abrasive/abrading portions 16 are of different grits or textures along the length of the abrading/abrasion portion 13. Preferably, however, the same dental abrading/abrasion floss 6 does not have a wide variant of grits or textures along its length (e.g. “fine” to “coarse” abrasive portions 16), but may if desired. Typically, however, the abrading/abrasion portion 13 has a range of abrasive portions 16 within a same or similar grit or texture range such as a range of “fine” grits, a range of “medium” grits, or a range of “coarse” grits. For instance, a first abrasive portion 16 (as arbitrarily viewed starting from the left side of FIG. 1) may have a “super, super fine” grit, then a “super fine” grit, and so forth within a range of “fine” grits.

Referring now to FIG. 2 there is depicted another embodiment of the present dental abrasion floss fashioned in accordance with the principles of the present invention. Particularly, there is depicted a piece of dental polishing and/or sanding floss, generally designated 18, fashioned in accordance with the present principles. The dental abrasion floss 18 is again defined by a length of dental floss 20 that is made from a fiber or fibrous material (collectively, fiber) that is preferably, but not necessarily, man-made or synthetic such as, but not limited to, nylon, rayon, Gore-tex® or the like. As such, the length of dental floss 8 may be a continuous thread/strand/piece/strip and/or the like (collectively piece), or an individual piece of any length.

In accordance with the principles of the present invention, the length of floss 20 has a finishing/polishing/sanding (abrading or abrasion) section 23 connected between portions 21 and 22 of the length of dental floss 20. The abrading/abrasion section 23 is formed of a flat plastic strip having a dental finishing/polishing/sanding (abrasion or abrading) material 24 impregnated into or coated onto the abrading/abrading section 23. The dental abrading material 24 is a gritty or textured material such as is known in the art for finishing, polishing and/or sanding (abrading) a dental restorative material (e.g. a dental resin). The dental polishing/sanding material 24 is of a single grit or texture such as “fine”, “medium”, “coarse” or the like. The flat plastic strip 23 may be an alternating pattern as in the embodiment of FIG. 1.

FIG. 2 also represents an embodiment of an abrading dental floss such as is described in connection with FIG. 1 wherein the abrading section 23 is not a plastic strip but is of a fiber dental floss. The abrading section 23 is of a gritty or textured material such as is known in the art for finishing, polishing and/or sanding (abrading) a dental restorative material (e.g. a dental resin). The dental polishing/sanding material 24 is of a single grit or texture such as “fine”, “medium”, “coarse” or the like. In this embodiment, it should be appreciated, that the abrasion section 23 is shown in FIG. 2 as an enlarged portion—this is for clarity to understand the nature of the abrading section 23 of the dental floss, but is not necessarily so. Particularly, the abrading/abrasion section 23 has been enlarged for detail in illustrating the continuous nature of the abrading portion 23 along the length thereof. The abrading/abrasion section 23 is thus preferably the same size as the dental floss. Therefore, reference to FIG. 3 is made to show what the embodiment of FIG. 2 looks like without such enlargement of the abrading section 23.

Referring to FIG. 3 there is depicted another embodiment of the present dental abrasion floss fashioned in accordance with the principles of the present invention. Particularly, there is depicted a piece of dental finishing, polishing and/or sanding (abrasion or abrading) floss, generally designated 30. The finishing/polishing/sanding floss 30 is defined by a length of dental floss 32 that is made from a fiber or fibrous material (collectively, fiber) that is preferably, but not necessarily, man-made or synthetic such as, but not limited to, nylon, rayon, Gore-tex® or the like. As such, the length of dental floss 32 may be a continuous thread/strand/piece/strip and/or the like (collectively piece), or an individual piece of any length.

In this embodiment, the length of floss 32 is entirely impregnated, coated or otherwise formed with a dental abrasion or abrading material 34 thereon. The abrasion or abrading material 34 is a gritty or textured material such as is known in the art for finishing, polishing and/or sanding (abrading) a dental restorative material (e.g. a dental resin). The dental abrasion or abrading material 34 is of a single “grit” such as “fine”, “medium”, “coarse” or the like.

While the invention has been illustrated and described in detail in the drawings and foregoing description, the same is to be considered as illustrative and not restrictive in character, it being understood that preferred embodiments have been shown and described and that all changes and modifications that come within the spirit of the invention are desired to be protected.

What is claimed is:

1. An element for abrading dental restorative material, the element comprising:
a length of fibrous dental floss; and
an abrasion section formed within the length of the fibrous dental floss;
the abrasion section incorporating an abrasion material suitable for abrading dental restorative material.

2. The element of claim 1, wherein the fibrous dental floss is synthetic.

3. The element of claim 1, wherein the abrasion material has a grit size comprising one of a fine texture, a medium texture and a coarse texture.

4. The element of claim 1, wherein the abrasion material has a grit size that increases along a length of the abrasion section.

5. The element of claim 1, wherein the abrasion section has alternating portions of the abrasion material and no abrasion material.

6. The element of claim 5, wherein sequential ones of the portions of the abrasion material has a grit size that increases along a length of the abrasion section.

7. An element for abrading dental restorative material, the element comprising:
a length of fibrous dental floss; and
an abrasion section formed along the entire length of the fibrous dental floss;
the abrasion section incorporating a dental restorative material abrading material.

8. The element of claim 7, wherein the fibrous dental floss is synthetic.

9. The element of claim 7, wherein the abrasion material has a grit size comprising one of a fine texture, a medium texture and a coarse texture.

10. The element of claim 7, wherein the abrasion material has a grit size that increases along a length of the abrasion section.

11. The element of claim 7, wherein the abrasion section has alternating portions of the abrasion material and no abrasion material.

12. The element of claim 11, wherein sequential ones of the portions of the abrasion material has a grit size that increase along a length of the abrasion section.

13. An element for abrading dental restorative material, the element comprising:
a length of dental floss formed of a synthetic fiber; and
an abrasion section formed between first and second portions of dental floss of the length of the dental floss;
the abrasion section incorporating a dental restorative material abrading material.

14. The element of claim 13, wherein the abrasion material has a grit size comprising one of a fine texture, a medium texture and a coarse texture.

15. The element of claim 13, wherein the abrasion material has a grit size that increases along a length of the abrasion section.

16. The element of claim 13, wherein the abrasion section has alternating portions of the abrasion material and no abrasion material.

17. The element of claim 16, wherein sequential ones of the portions of the abrasion material has a grit size that increases along a length of the abrasion section.

18. The element of claim 13, wherein the abrasion section is formed of a plastic strip.

19. The element of claim 18, wherein the plastic strip has alternating portions of the abrasion material and no abrasion material.

20. The element of claim 18, wherein the abrasion material has a grit size that increases along a length of the plastic strip.
